(19) United States
(12) Patent Application Publication
(10) Pub. No.: US 2016/0303984 A1
(43) Pub. Date: Oct. 20, 2016

(54) CHARGING DEVICE FOR VEHICLE

(71) Applicant: Hyundai Motor Company, Seoul (KR)

(72) Inventors: Dea Woo Lee, Gyeongsangbuk-do (KR); Si Hun Yang, Hwaseong (KR); Jin Young Yang, Hanam (KR); In Yong Yeo, Bucheon (KR); Byeong Seob Song, Yongin (KR); Woo Young Lee, Cheongju (KR)

(21) Appl. No.: 14/883,108

(22) Filed: Oct. 14, 2015

(30) Foreign Application Priority Data
Apr. 14, 2015 (KR) 10-2015-0052289

(51) Int. Cl. B60L 11/18

(52) U.S. Cl. CPC B60L 11/1809

(57) ABSTRACT

A vehicle charging device is provided and efficiently operates a converter to charge a battery mounted within vehicles. The vehicle charging device includes a power-supply unit that provides a direct current (DC) voltage and a DC/DC converter that converts the DC voltage received from the power-supply unit into a battery charging voltage. The converter also includes an active snubber that is mounted to a secondary coil of a main transformer. The converter is configured to reduce a peak noise generated from the secondary coil using the active snubber and transmit the resultant voltage having the reduced peak noise to an output terminal.

### CROSS-REFERENCE TO RELATED APPLICATION

This application claims the benefit of priority to Korean Patent Application No. 10-2015-0052289, filed on Apr. 14, 2015, the disclosure of which is hereby incorporated in its entirety by reference.

### BACKGROUND

The present disclosure relates to a charging device for a vehicle, and more particularly to a technology for efficiently operating a converter configured to charge a battery mounted within hybrid electric vehicles (HEVs) or fuel cell vehicles. In association with the development of eco-friendly vehicles (e.g., plug-in hybrid electric vehicles (HEVs), electric vehicles (EVs), fuel cell electric vehicles (FCEVs), etc.), On-Board Charger (OBCs) may be used to charge a high-voltage battery.

Particularly, the OBC may include a power factor correction (PFC) boost converter configured to convert an alternating current (AC) power into a direct-current (DC) power to improve a power factor; and an insulation-type DC/DC converter configured to convert the DC power voltage obtained from the PFC boost converter into a battery charging voltage. The DC/DC converter is configured to convert a high-voltage DC power generated from a high-voltage battery of a vehicle into a low-voltage DC power, to charge an auxiliary battery and monitor the entire load of the vehicle.

However, since the OBC has a relatively-high output voltage, a high-voltage spike or increase may occur in the transformer of the DC/DC converter. In other words, excessive peak noise may occur in the output diode of the DC/DC converter due to a high resonance frequency, resulting in the occurrence of a high surge voltage. As a result, rectifying elements may be damaged or lost, or high-priced elements capable of efficiently covering a spike voltage are required. In addition, rectifying elements having high internal pressure are unfavorable or disadvantageous in terms of loss or damage, resulting in reduction of production efficiency.

### SUMMARY

Various exemplary embodiments of the present disclosure are directed to providing a charging device for a vehicle that substantially obviates one or more problems due to limitations and disadvantages of the related art.

An exemplary embodiment of the present disclosure relates to a technology for removing a resonance inductor for a snubber and a diode from a primary coil of a transformer, adding a snubber circuit to a secondary coil of the transformer, to prevent a surge voltage spike from occurring in each output diode of a converter, resulting in reduction of production costs.

In accordance with an aspect of the exemplary embodiment, a vehicle charging device may include: a power-supply unit configured to provide a direct current (DC) voltage; and a DC/DC converter configured to convert the DC voltage received from the power-supply unit into a battery charging voltage, wherein the DC/DC converter may include an active snubber mounted to a secondary coil of a main transformer, may be configured to reduce a peak noise generated from the secondary coil using the active snubber, and transmit the resultant voltage having the reduced peak noise to an output terminal.

It is to be understood that both the foregoing general description and the following detailed description of the present disclosure are exemplary and explanatory and are intended to provide further explanation of the embodiments as claimed.

### BRIEF DESCRIPTION OF THE DRAWINGS

The objects, features and advantages of the present invention will be more apparent from the following detailed description in conjunction with the accompanying drawings, in which:

FIG. 1 is a circuit diagram illustrating a vehicle charging device according to an exemplary embodiment of the present disclosure.

FIGS. 2A-2B are diagrams illustrating effects of the vehicle charging device shown in FIG. 1 according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the invention. As used herein, the singular forms “a”, “an” and the are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Reference will now be made in detail to the exemplary embodiments of the present disclosure, examples of which are illustrated in the accompanying drawings. Wherever possible, the same reference numbers will be used throughout the drawings to refer to the same or like parts.

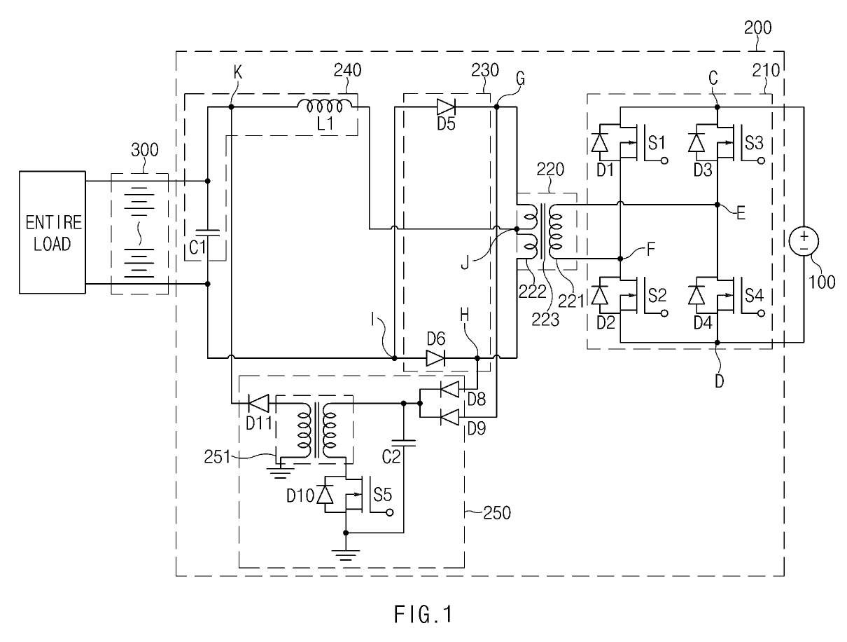

FIG. 1 is a circuit diagram illustrating a vehicle charging device according to an exemplary embodiment of the present disclosure. Referring to FIG. 1, the vehicle charging device according to the exemplary embodiment may include a power-supply unit 100, a DC/DC converter 200, and a high-voltage battery 300. In particular, a controller may be configured to operate the power-supply unit 110, the DC/DC converter 200, and the high-voltage battery 300.

The power-supply unit 100 may be configured to supply a DC power source having a high-voltage level to a DC/DC converter 200. The DC/DC converter 200 may include a switching unit 210, a main transformer 220, a rectifying unit 230, a filtering unit 240, and an active snubber 250. The controller may also be configured to operate the various units of the DC/DC converter 200. Additionally, the DC/DC converter 200 may be configured to convert a DC voltage received from the power-supply unit 100 into a battery charging voltage, and supply the battery charging voltage to the high-voltage battery 300. In particular, the switching unit 210 may include a plurality of switching elements S1˜S4 and a plurality of diodes D1˜D4. The switching unit 210 may be configured to convert a DC voltage received from the power-supply unit 100 into an alternating (AC) voltage.

The exemplary embodiment discloses that the switching unit 210 may include a plurality of switching elements S1˜S4 and a plurality of diodes D1˜D4 for convenience of description and better understanding of the present disclosure. However, the scope or spirit of the present disclosure is not limited thereto, and it should be noted that the circuit and connection structures of the switching unit 210 may be changed or modified without departing from the scope or spirit of the present disclosure.

The switching elements (S1, S2) may be coupled in series between a node C and a node D and the switching elements (S3, S4) may be coupled in series between the node C and the node D. A drain terminal of the switching element S1 may be coupled to the node C, and a source terminal thereof may be coupled to a node F. A drain terminal of the switching element S2 may be coupled to the node D, and a source terminal thereof may be coupled to the node F. Further, a drain terminal of the switching element S3 may be coupled to the node C, and a source terminal thereof may be coupled to a node E. A drain terminal of the switching element S4 may be coupled to the node D, and a source terminal thereof may be coupled to the node E.

The diodes D1˜D4 may be coupled in parallel to the switching elements S1˜S4, respectively. The switching element 210 may be configured to adjust a duty cycle by changing a phase of a turn-on signal for turning on the switching elements S1˜S4, to thus adjust a voltage supplied to the nodes (E, F). In other words, the switching element 210 may be configured to adjust a pulse width of a voltage supplied to a primary coil 221 based on a turn-on cycle in which the switching elements S1˜S4 are simultaneously turned on.

The gate terminals of each switching elements S1˜S4 may be coupled to a separate control circuit (not shown). The on/off operations of the switching elements S1˜S4 and the signal phases may be executed under operation of a control circuit (e.g., the controller). In particular, the switching elements S1˜S4 may be formed of Metal Oxide Semiconductor Field Effect Transistors (MOSFETs).

The main transformer 220 may include a primary coil 221, a core 223, and a secondary coil 222. The main transformer 220 may be configured to convert a high AC voltage received from the nodes (E, F) into a low AC voltage, and output the low AC voltage to the rectifying unit 230. In addition, the main transformer 220 may be configured to perform electrical insulation between a high voltage and a chassis. Particularly, the primary coil 221 and the secondary coil 222 may be formed at both sides of the core 223. The primary coil 221 may be coupled to the nodes (E, F) and the secondary coil 222 may be coupled to the nodes (G, H).

The rectifying unit 230 may include a plurality of rectifying diodes (D5, D6). The rectifying diodes (D5, D6) may be configured to rectify AC power received from the node I (e.g., output terminal) into DC power to output the DC power to a filtering unit 240 and an active snubber 250. The rectifying diodes (D5, D6) may be connected in a forward direction from the node I to the nodes (G, H). The filtering unit 240 may include an inductor L1 and a capacitor C1 to filter and smooth the output voltage of the rectifying unit 230. The inductor L1 may be a smoothing inductor configured to reduce ripples of the output current of the node J and may be coupled between the node J and the node K.

The capacitor C1 may be coupled between the node K and the node I. Further, the capacitor C1 may be configured to reduce ripples of the output voltage applied to the node K. The capacitor C1 may be a smoothing capacitor configured to constantly maintain a voltage applied to the node K. The output voltages of the inductor L1 and the capacitor C1 may be supplied to the high-voltage battery 300. The high-voltage battery 300 may be configured to power on the entire load.

In addition, the active snubber 250 may be coupled to the output terminal of the rectifying unit 230 to absorb a surge voltage (e.g., voltage spike generated from the rectifying unit 230) or a ringing voltage. In other words, the active snubber 250 may be configured to reduce an inverse voltage generated from the rectifying diodes (D5, D6) of the rectifying unit 230. The active snubber 250 may include a plurality of diodes D8˜D11, a capacitor C3, a switching element S5, and a transformer 251.

Particularly, the diode D8 may be coupled between the node H and the capacitor C2 in a forward direction. The diode D9 may be coupled between the node G and the capacitor C2 in a forward direction. The diodes (D8, D9) may be configured to rectify a voltage received from the nodes (G, H) and output the rectified voltage to the capacitor C2 and the transformer 251. The capacitor C2 may be coupled between a ground voltage terminal and the diodes (D8, D9). The transformer 251 may be configured to perform conversion of the output voltage of the diodes (D8, D9) and output the converted result to the diode D11. Additionally, the transformer 251 may be configured to convert a high input voltage received from the diodes (D8, D9) into a low voltage and output the low voltage to the diode D11.

The diode D11 may be coupled between the transformer 251 and the node K in a forward direction. The diode D11 may be configured to rectify the voltage received from the transformer 251 and output the rectified voltage to the node K. The switching element S5 may be coupled between the transformer 251 and the ground voltage terminal. The diode D10 may be coupled in parallel to the switching element S5. In particular, each switching element S5 may be formed of MOSFET.

For example, when the switching element S5 is turned on, an input voltage of the transformer 251 may be discharged to the ground voltage terminal, resulting in reduction of the input voltage. In contrast, when the switching element S5 is turned off, the input voltage of the transformer 251 may be re-increased. A gate terminal of the switching element S5 may be coupled to a separate control circuit (not shown). The on/off operation and the signal phase of the switching element S5 may be executed under control of the control circuit (e.g., the controller).

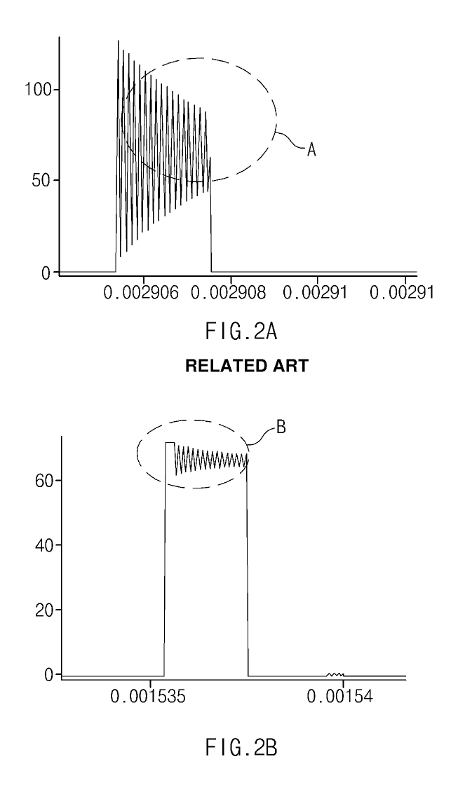

When a resonance frequency is substantially high, a current flowing into the output terminals of the diodes (D5, D6) may increase thus causing a peak noise flowing into the secondary coil 222 of the main transformer 220 to increase. FIG. 2A illustrates an exemplary case in which a peak noise is excessively increased according to the related art.

Assuming that a peak current is increased, when the switch of the DC/DC converter 200 is turned off, a turn-off loss may increase and a root mean square (RMS) current of a reading switch may also increase. As a result, conduction loss may increase and On-Board Charger (OBC) efficiency may decrease. Therefore, according to the exemplary embodiment, a peak voltage generated from the output terminals of the diodes (D5, D6) may be absorbed through the active snubber 250 as shown in FIG. 2B.

In other words, the exemplary embodiment of the present disclosure may reduce parasitic capacitance generated from the output diodes (D5, D6) and noise energy of the switch generated by leakage inductance of the main transformer 220. The exemplary embodiment may reduce an inverse voltage generated from the output diodes (D5, D6), and transmit the reduced voltage to the output capacitor C1 to remove a peak noise.

The exemplary embodiment does not include a high-current resonance inductor or a high-voltage diode in the primary coil 221 of the main transformer 220. In addition, the exemplary embodiment may include the active snubber 250 in the secondary coil 222 of the main transformer 220 to maintain snubber effect and at the same time may use a low voltage and a low current. As a result, the vehicle charging device according to the exemplary embodiment may be comprised of relatively low-priced electronic components, resulting in reduction of production costs and improvement of product efficiency.

As is apparent from the above description, the snubber circuit may be added to the secondary coil of the transformer according to the exemplary embodiment, to prevent surge voltage spike generated from the output diodes of the converter -from occurring, to increase product efficiency, resulting in reduction of production costs.

The exemplary embodiments of the present disclosure have been disclosed herein merely for illustrative purposes, and those skilled in the art will appreciate that various modifications, additions and substitutions are possible, without departing from the scope and spirit of the disclosure as disclosed in the accompanying claims.

What is claimed is:

1. A vehicle charging device, comprising:
a power-supply unit configured to provide a direct current (DC) voltage; and
a DC/DC converter configured to convert the DC voltage received from the power-supply unit into a battery charging voltage, including an active snubber mounted to a secondary coil of a main transformer, reduce a peak noise generated from the secondary coil using the active snubber, and transmit the resultant voltage having the reduced peak noise to an output terminal.

2. The vehicle charging device according to claim 1, wherein the DC/DC converter includes:
a switching unit configured to adjust a voltage supplied to a primary coil of the main transformer based on whether several switching elements are turned on or off;
the main transformer configured to receive an alternating current (AC) voltage through the switching operation of the switching unit, and transmit the AC voltage to the secondary coil;
a rectifying unit configured to rectify the voltage received from the output terminal; and
a filtering unit configured to filter a voltage received from the secondary coil of the main transformer,
wherein the active snubber contained in the secondary coil is configured to reduce peak noise generated from the rectifying unit, and transmit the resultant voltage having the reduced peak noise to the output terminal.

3. The vehicle charging device according to claim 2, wherein the rectifying unit includes:
a first diode configured to rectify a voltage of a first output terminal, and transmit the rectified voltage to a first node; and
a second diode configured to rectify a voltage of a second output terminal, and transmit the rectified voltage to a second node.

4. The vehicle charging device according to claim 2, wherein the filtering unit includes:
an inductor coupled between the secondary coil and a first output terminal; and
a first capacitor coupled between the first output terminal and an input terminal of the rectifying unit.

5. The vehicle charging device according to claim 2, wherein the active snubber includes:
a third diode configured to rectify a voltage received from a first node of the rectifying unit;
a fourth diode configured to rectify a voltage received from a second node of the rectifying unit;
a second capacitor coupled among the third diode, the fourth diode, and a ground voltage terminal;
a transformer configured to convert the output voltages of the third diode and the fourth diode;
a fifth diode configured to output an output signal of the transformer to a first output terminal of the filtering unit;
a switching element coupled between the transformer and the ground voltage terminal; and
a sixth diode coupled in parallel to the switching element.

6. The vehicle charging device according to claim 5, wherein the active snubber is configured to selectively discharge an input voltage of the transformer based on a turn-on or turn-off operation of the switching element, reduce a peak voltage generated in the rectifying unit, and output the resultant voltage having the reduced peak voltage to the first output terminal.

7. The vehicle discharging device according to claim 2, wherein the switching unit includes a plurality of switching elements.

8. The vehicle discharging device according to claim 7, wherein the switching elements may be formed of Metal Oxide Semiconductor Field Effect Transistors (MOSFETs).
